(19) United States
(12) Patent Application Publication
(10) Pub. No.: US 2005/0236791 A1
(43) Pub. Date: Oct. 27, 2005

(54) Steering power assist for 2 or 3 wheel motorcycles

(76) Inventor: William James Carr, San Jose, CA (US)

Correspondence Address: WILLIAM JAMES CARR, 1298 BALLARD COURT, SAN JOSE, CA, 95131, US

(21) Appl. No.: 10/832,144

(22) Filed: Apr. 26, 2004

(51) Int. Cl. B62K 21/00

(52) U.S. Cl. 280/92

(57) ABSTRACT

Disclosed herein is a Invention which communicates physical assistance to steering a conventional two wheel or three wheel motorcycle. As it can be used to fine tune a two wheel motorcycle. The invention when applied to a three wheel motorcycle, or also referred to as a tricycle, quite profoundly eases the steering input necessary by the operator. In a three wheel application, steering becomes harder proportionally as the vehicle is turned from straight a head to its maximum turning angle, right or left. This invention can be adjusted to all but eliminate, the input forces applied by the operator proportionately relevant to steering angle. Ease of installation and steering assist adjust ability plus ease of manufacture are also note worthy.

### CROSS-REFERENCE TO RELATED APPLICATIONS

No related prior art found.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Modem typical two wheel Motorcycles all share a common set of parameters relevant to the handling underway. To steer these vehicles typically requires leaning of the body to cause direction change, and some input to the handlebars also assists steering. Although these forces are tolerable in a two wheel application, in a three wheel application these forces become dramatically more difficult because of a geometry change in a three wheel application.

### BRIEF SUMMARY OF THE INVENTION

Although, this Invention is capable of fine tuning the steering forces of any two wheel motorcycle, the real advantage is realized in a three wheel application as the effects and force required for turning are greatly increased. In a three-wheel application, body lean is of little consequence and input to the handlebars is the only means to steer. The Invention through mechanical means, can remove any amount of force required to steer by virtue of adjustment. This causes a more desirable operating environment for the operator.

### BRIEF DESCRIPTION OF THE SEVERAL VIEWS OF THE DRAWING

Drawing # 1 of 3: Shows all the components of the Invention from a elevated view

Drawing # 2 of 3: Shows how the Invention attaches to a conventional modem motorcycle

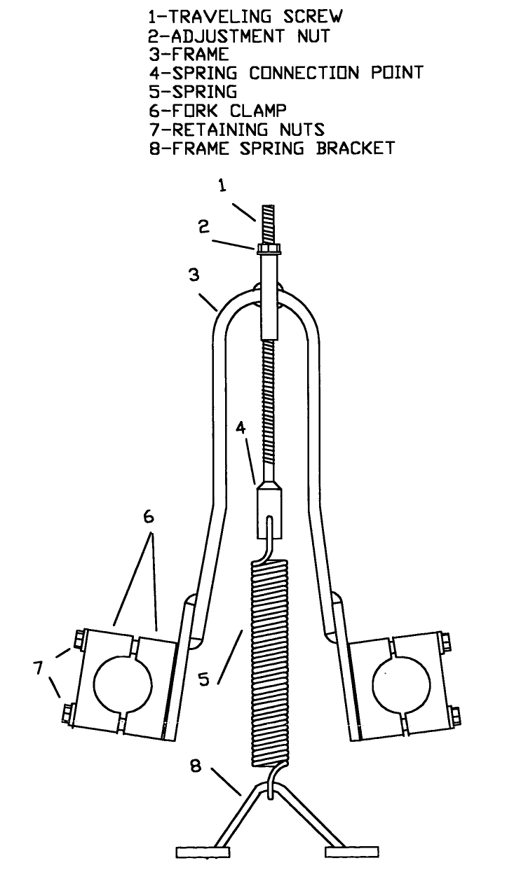

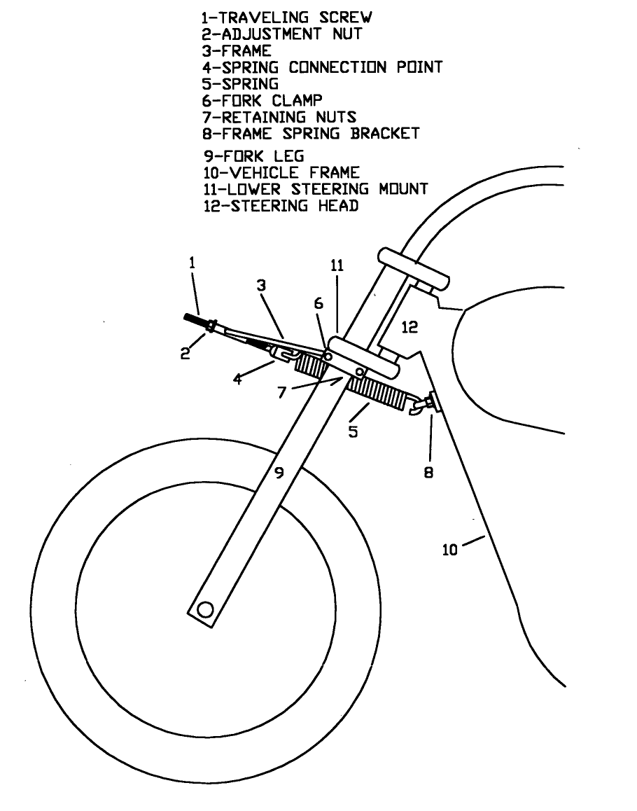

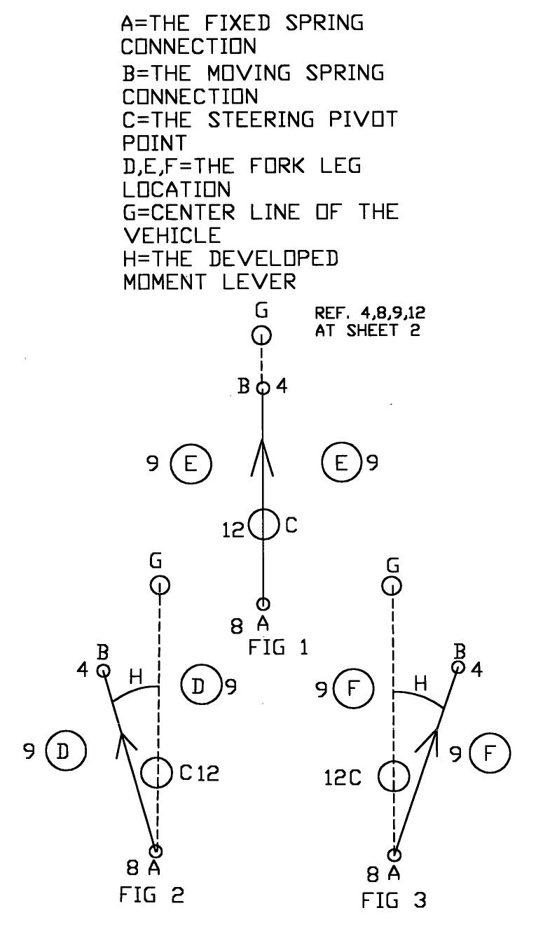

Drawing # 3 of 3: Shows by illustration, The geometry effects. Fig 1 —straight ahead steering FIG. 2—Left steering, FIG. 3—Right steering

### DETAILED DESCRIPTION OF THE INVENTION

This invention is all about being able to steer a two or three wheel motorcycle using less physical force. Caster needed to stabilize the steering is also a force to overcome while forward motion is occurring. This caster effect is necessary to cause stability to the unique geometry of a motorcycle steering system.

Understanding the need for caster retention, but also, reduction of steering force is the essence of the invention. The available counter force is produced by a heavy spring 5 which is always loaded to a defined adjusted tension by the traveling screw 1 hooked to the spring at the spring connection point 4 and tensioned by the adjusting nut 2 supported by the invention frame 3. The other end of the spring is connected to the frame spring bracket 8. The Frame 3 is bolted To the fork clamps 6, and secured by through bolts 7. Mounting of the Invention to a conventional motorcycle is accomplished by connecting the fork clamps 6 to the fork leg 9. The frame spring bracket 8 will then be connected to The vehicle frame 10.

Variations in dimensions of the fork legs 9 and vehicle frame 10 shapes will cause fundamental dimension changes in the Invention.

Typically, all components will be made of steel except the fork clamps 6 which are not so structurally challenged and can be made from aluminum. All steel components will be either welded or machined.

Drawing # 3 is about the geometry and how the force is generated to assist steering. Remember the spring is always stretched and loaded in other words, the force is always present. FIG. 1 illustrates a straight ahead steering direction. Note, although the spring is loaded no force is transmitted to the steering. FIG. 2 illustrates a left turn which shows a moment lever H effect allowing the spring force to pull with the direction being steered. This lever is of course proportional to the steered angle. Caster as part of the common vehicle design is not effected in the straight ahead direction.

1: A mechanical device which will assist the operator of a two wheel or three wheel, motor driven cycle in overcoming the steering forces naturally exhibited by modern design while retaining the effects of the preferred, common vehicle geometry and caster design.

2: Unique adjust ability and adaptability to current vehicle design. A traveling screw to tension the spring Which effects the assistance to steering and allows easy installation.

3: Proportional assistance to steering created by a Moment lever directed by steering input, working in concert with the proportional load.
